(19) United States
(12) Patent Application Publication
(10) Pub. No.: US 2019/0394239 A1
(43) Pub. Date: Dec. 26, 2019

(54) APPLICATION BASED POLICY MANAGEMENT USED WITH A CLIENT AND A SERVICE PROVIDER

(71) Applicant: GM Global Technology Operations LLC, Detroit, MI (US)

(72) Inventor: Steven Hartley, Pointe-Claire (CA)

(21) Appl. No.: 16/013,279

(22) Filed: Jun. 20, 2018

(51) Int. Cl. H04L 29/06; H04W 48/16; H04W 12/06; H04W 12/08; H04W 4/50

(52) U.S. Cl. CPC H04L 63/20; H04L 63/101; H04W 48/16; H04W 84/12; H04W 12/08; H04W 4/50; H04W 12/06

(57) ABSTRACT

A system and method for managing an application based policy between a client and a service provider includes communicating, by the client, with the service provider and determining, by the client based on an application policy, whether an application stored by the client has permission to access the service provider, wherein the application policy is part of a management object and sets an access permission of the application to the service provider.

### INTRODUCTION

The present disclosure relates generally to a system and method for managing an application based policy between a client and a service provider in a wireless communication system.

Wireless communication systems, including the infrastructure for wireless local area networks (WLAN) and wireless fidelity (Wi-Fi) access points, generally operate under the protocols of the Institute of Electrical and Electronics Engineers (IEEE) 802.11 series of standards. Recent efforts have been devoted to developing a series of standards to simplify the connection of a client, such as a mobile device, with a public Wi-Fi hotspot or cellular network while roaming. For example, the Wi-Fi Alliance® supports a certification program and technical specifications for Wi-Fi Certified Passpoint™, also known as Wi-Fi Hotspot 2.0, which enables a secure and automatic connection between a client and a service provider, such as a public Wi-Fi hotspot or cellular network, even while roaming. Other examples include the IEEE 802.11u technical specifications and the Wireless Broadband Alliance Next Generation Hotspot initiative.

As clients connect to various Wi-Fi hotspots with different service providers, it is possible that certain software application traffic and/or functionality will be supported or restricted, based on the partnership arrangement between the application developer and the server provider. Thus, there is a need to manage the access permissions of an application on the client that takes into account the functionality between the application and the service provider.

### SUMMARY

According to several aspects, a method for managing an application based policy between a client and a service provider includes communicating, by the client, with the service provider and determining, by the client based on an application policy, whether an application stored by the client has permission to access the service provider, wherein the application policy is part of a management object and sets an access permission of the application to the service provider.

In one aspect, the management object further includes objects for credentials and associated data that have been provisioned by the service provider.

In another aspect, the management object is associated with a set of protocols which allow the client to connect with service providers by saving client credentials and resubmitting the client credentials each time the client connects.

In another aspect, the management object is a PerProviderSubscription Management Object used by protocols sourced by Wi-Fi Certified Passpoint™.

In another aspect, the application policy includes an access type object which indicates what kind of access permission the application policy sets.

In another aspect, the access type object includes a type wherein the application has unrestricted access to the service provider.

In another aspect, the access type object includes a whitelist type wherein the application has unrestricted access to the service provider if the application is on an application policy list and is blocked from access to the service provider if the application is not on the application policy list.

In another aspect, the access type object includes a blacklist type wherein the application has unrestricted access to the service provider if the application is not on an application policy list and is blocked from access to the service provider if the application is on the application policy list.

In another aspect, the access type object includes a vendor type wherein only an application associated with a particular vendor is allowed access to the service provider.

In another aspect, the application policy includes an application policy list, wherein the application is listed in the application policy list and identified by a unique application identification.

In another aspect, the client is a motor vehicle.

In another aspect, the client is a mobile device.

In another aspect, the communicating, by the client, with the service provider includes wirelessly communicating via an access point.

According to several other aspects, a system for managing an application based policy with a service provider includes a transceiver configured to communicate wirelessly with the service provider, a processor connected to the transceiver, and a memory for storing computer code for execution by the processor. The computer code is configured to communicate with the service provider using the transceiver and determine based on an application policy whether an application stored by the memory has permission to access the service provider, wherein the application policy is part of a management object and sets an access permission of the application to the service provider.

In one aspect, the management object is specific to the service provider and includes credentials.

In another aspect, the application policy includes an access type object which indicates what kind of access permission the application policy sets and an application policy list which includes the application.

In another aspect, the access type object includes a type wherein the application has unrestricted access to the service provider, a whitelist type wherein the application has unrestricted access to the service provider if the application is on an application policy list and is blocked from access to the service provider if the application is not on the application policy list, a blacklist type wherein the application has unrestricted access to the service provider if the application is not on an application policy list and is blocked from access to the service provider if the application is on the application policy list, or a vendor type wherein only an application associated with a particular vendor is allowed access to the service provider.

In another aspect, the application is identified by a unique application identifier.

In another aspect, the service provider sets the access permission of the application.

According to several other aspects, a non-transitory machine-readable storage medium storing instructions that upon execution: communicate wirelessly with a service provider, and determine based on an application policy whether an application stored by the storage medium has permission to access the service provider, wherein the application policy is part of a management object and sets an access permission of the application to the service provider, wherein the application policy includes an access type which indicates what kind of access permission the application policy sets and an application policy list which includes the application.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of an exemplary wireless network architecture diment;

FIG. 2 is a schematic view of an exemplary client; and

FIG. 3 is a tree map illustrating an exemplary embodiment of an application based policy.

### DETAILED DESCRIPTION

The following description is merely exemplary in nature and is not intended to limit the present disclosure, application, or uses.

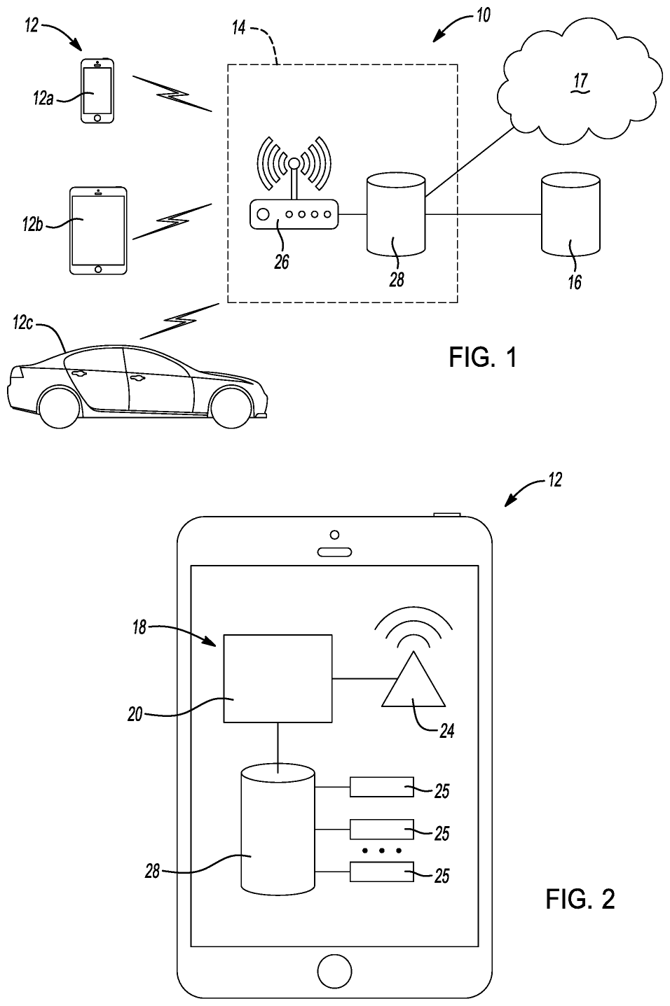

Referring to FIG. 1, an example of a wireless network architecture for use with the present invention is generally indicated by reference number 10. It should be appreciated that other wireless network architecture 10 may be used without departing from the scope of the present disclosure. The wireless network architecture 10 is preferably configured as a Wi-Fi Certified Passpoint™ (Release 2 or later) Wi-Fi network, hereinafter referred to as “Hotspot 2.0”. A description of Hotspot 2.0 is provided in Wi-Fi Alliance Hotspot 2.0 (release 2) Technical Specification Version 1.2, 2016, herein incorporated by reference. The wireless network architecture 10 may have other configurations, including a network operative under the IEEE 802.11u technical specifications and the Wireless Broadband Alliance Next Generation Hotspot initiative, without departing from the scope of the present disclosure. The wireless network architecture 10 includes a client 12 that communicates with a Wi-Fi hotspot 14, a roaming partner or service provider 16, and an internet protocol network 17, such as the Internet.

The client 12 is any mobile device having Wi-Fi capabilities. For example, the client 12 may be a phone or smartphone 12A, a tablet or computer 12B, or a motor vehicle 12C, to name but a few. Referring briefly to FIG. 2, the client 12 generally includes a controller 18 which is a non-generalized, electronic control device having a preprogrammed digital computer or processor 20, memory or non-transitory computer readable medium 22 used to store data such as control logic, software applications, instructions, computer code, data, lookup tables, etc., and a transceiver 24. computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code. The processor 20 is configured to execute the code or instructions. Where the client 12 is a motor vehicle 12C, the controller 18 may be a dedicated Wi-Fi controller or an engine control module, a transmission control module, a body control module, an infotainment control module, etc. The transceiver 24 is configured to wirelessly communicate with the hotspot 14 using Wi-Fi protocols under IEEE 802.11x.

The client 12 further includes one or more applications 25. An application 25 is a software program configured to perform a specific function or set of functions. The application 25 may include one or more computer programs, software components, sets of instructions, procedures, functions, objects, classes, instances, related data, or a portion thereof adapted for implementation in a suitable computer readable program code. The applications 25 may be stored within the memory 22 or in additional or separate memory. Examples of the applications 25 include audio or video streaming services, games, browsers, social media, etc.

Returning to FIG. 1, the hotspot 14 is a site that offers access to packet data services, such as the Internet 17, using a Wi-Fi access network. The hotspot 14 may be public or private. The hotspot 14 includes an access point 26 and a local server 28. The access point 26 is a device or set of devices, such as a router, that instantiates any required IEEE 802.11 logical functions including security and authentication, as defined in IEEE 802.11-2012. The access point 26 may include additional control, user and management functions. The local server 28 is a local authentication, authorization and accounting (AAA) server and local online sign up (OSU) server.

The service provider 16 provides the network services of the hotspot 14. The service provider 16 includes remote AAA servers, remote OSU servers, subscriber management systems, and home location register (HLR) and high speed serial (HSS) interfaces, etc.

When roaming, the client 12 scans for access points with which to connect using, for example, access network query protocol (ANQP) and extensible authentication protocol (EAP). Once an access point 26 is detected, the client 12 communicates with the access point 26 and sets up a new account with the hotspot 14 and service provider 16 if the client 12 does not already have valid credentials for the selected hotspot 14 and service provider 16. Next, the client 12 is provisioned by the service provider 16 with a subscription management object. The subscription management object establishes credential information and provides policy information to the client 12 if the client 12 does not already have valid credentials for the selected hotspot 14 and service provider 16. Once provisioned, the client 12 is successfully associated and authenticated with the hotspot 14 and can access the services for which the client has subscribed.

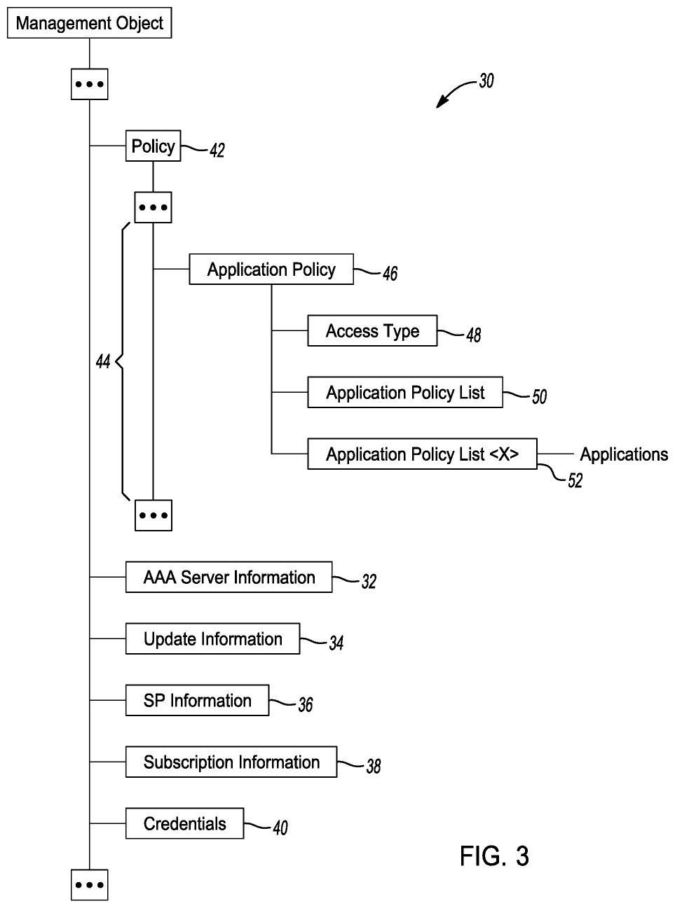

The subscription management object is shown as a tree map in FIG. 3 and generally indicated by reference number 30. It should be appreciated that only a portion of the subscription management object 30 is illustrated in FIG. 3. The subscription management object 30 includes nodes, objects, or fields that contain data. The subscription management object 30 generally includes an AAA server information node 32, an update information node 34, a service provider (SP) information node 36, a subscription information node 38, a credentials node 40, and a policy node 42. The AAA server information node 32 identifies AAA server trust root(s) used by the client 12 in validating the AAA server's identify. The update information node 34 includes parameters that identify the subscription server along with metadata related to SP subscription updates and subscription remediation. The SP information node 36 provides information related to the service provider to determine if the hotspot 14 is a home or visited network. The subscription information node 38 includes information related to the subscription parameters such as type of subscription, date of subscription, expiration date of subscription, usage limits, etc. The credentials node 40 includes the credentials of the subscription, including username and password, digital certificate, subscriber identify module (SIM), etc. The policy node 42 includes information related to the policy of the service provider. An example of the above referenced nodes in a subscription management object is the PerProviderSubscription Management Object according to the Hotspot 2.0 specification.

The subscription management object 30 further includes an application policy 44. In the example provided, the application policy 44 is disposed under/within the policy node 42. However, it should be appreciated that the application policy 44 may be disposed elsewhere within the subscription management object 30 without departing from the scope of the present disclosure. The application policy 44 sets an access permission of one or more of the applications 25 relative to the service provider 16.

The application policy 44 includes an application policy node 46. The application policy node 46 stores the application policy and is characterized as follows:

| STATUS | OCCURRENCE | FORMAT | ACCESS TYPES |
|---|---|---|---|
| Optional | Zero to One | Node | Add, Delete, Get, |
| | | | Replace |

wherein the “Status” indicates whether the whether the client 12 must support the node. If the Status is “Required”, then the client 12 shall support that node, provided the parent node of this node is supported. If the Status is “Optional”, the client 12 is not required to support the node. The “Occurrence” indicates how often the node may appear. The “Format” indicates the format of the node. For example, “Node” indicates the node acts as a storage for any nodes associated therewith, “Integer” indicates the node includes an integer number that corresponds to certain options, and “Characters” indicates the node includes alphanumeric characters. The “Access Types” indicates how the node may be modified and include “Add, Delete, Get, Replace” or “Get, Replace”.

Under the application policy node 46 is an access type node 48, an application policy list node 50, and an application policy list node <X>52. The access type node 48 contains information related to what kind of access permission the application policy sets and is characterized as follows:

| STATUS | OCCURRENCE | FORMAT | ACCESS TYPES |
|---|---|---|---|
| Required | One | Integer | Get, Replace |

The integer value may refer to one of four access types. In one example, the access type node includes a type wherein the applications 25 have unrestricted access to the service provider 16. In another example, the access type node includes a whitelist type wherein the applications 25 have unrestricted access to the service provider 16 if the applications 25 are on an application policy list and are blocked from access to the service provider 16 if the applications 25 are not on the application policy list. In another example, the access type node includes a blacklist type wherein the applications 25 have unrestricted access to the service provider 16 if the applications 25 are not on the application policy list and are blocked from access to the service provider 16 if the applications 25 are on the application policy list. In another example, the access type object includes a vendor type wherein only applications 25 associated with a particular vendor are allowed access to the service provider 16.

The application policy list node 50 is a node for storing the application policy list and is characterized as follows:

| STATUS | OCCURRENCE | FORMAT | ACCESS TYPES |
|---|---|---|---|
| Required | Zero to One | Node | Add, Delete, Get, |
| | | | Replace |

The application policy list <X>52 is a dynamic node that stores the application policy list in character format and is characterized as follows:

| STATUS | OCCURRENCE | FORMAT | ACCESS TYPES |
|---|---|---|---|
| Required | One or More | Character | Add, Delete, Get, |
| | | | Replace |

The application policy list includes a list of applications 25 for which access permission is to be defined. In one example, the applications 25 are listed according to a unique application identifier (ID). Application ID's may be those associated with the Android operating system and/or the Apple operating system.

During use, the client 12 communicates with the hotspot 14, as noted above. The client 12 then determines whether any given application 25 has permission to access the hotspot 14 and communicate with the service provider 16 based on the application policy 44 within the subscription management object 30. Therefore, applications 25 that may have restricted functionality with a given service provider 16 may be prohibited from accessing the hotspot 14, etc.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for managing an application based policy between a client and a service provider, the method comprising:
communicating, by the client, with the service provider; and
determining, by the client based on an application policy, whether an application stored by the client has permission to access the service provider, wherein the application policy is part of a management object and sets an access permission of the application to the service provider.

2. The method of claim 1 wherein the management object further includes nodes for credentials and associated data that have been provisioned by the service provider.

3. The method of claim 1 wherein the management object is associated with a set of protocols which allow the client to connect with service providers by saving client credentials and resubmitting the client credentials each time the client connects.

4. The method of claim 1 wherein the management object is a PerProviderSubscription Management Object used by protocols sourced by Wi-Fi Certified Passpoint™.

5. The method of claim 1 wherein the application policy includes an access type node which indicates what kind of access permission the application policy sets.

6. The method of claim 5 wherein the access type node includes a type wherein the application has unrestricted access to the service provider.

7. The method of claim 5 wherein the access type node includes a whitelist type wherein the application has unrestricted access to the service provider if the application is on an application policy list and is blocked from access to the service provider if the application is not on the application policy list.

8. The method of claim 5 wherein the access type node includes a blacklist type wherein the application has unrestricted access to the service provider if the application is not on an application policy list and is blocked from access to the service provider if the application is on the application policy list.

9. The method of claim 5 wherein the access type node includes a vendor type wherein only an application associated with a particular vendor is allowed access to the service provider.

10. The method of claim 1 wherein the application policy includes an application policy list, wherein the application is listed in the application policy list and identified by a unique application identification.

11. The method of claim 1 wherein the client is a motor vehicle.

12. The method of claim 1 wherein the client is a mobile device.

13. The method of claim 1 wherein the communicating, by the client, with the service provider includes wirelessly communicating via an access point.

14. A system for managing an application based policy with a service provider, the system comprising:
a transceiver configured to communicate wirelessly with the service provider;
a processor connected to the transceiver; and
a memory for storing computer code for execution by the processor, the computer code configured to:
communicate with the service provider using the transceiver; and
determine based on an application policy whether an application stored by the memory has permission to access the service provider, wherein the application policy is part of a management object and sets an access permission of the application to the service provider.

15. The system of claim 14 wherein the management object is specific to the service provider and includes credentials.

16. The system of claim 14 wherein the application policy includes an access type node which indicates what kind of access permission the application policy sets and an application policy list which includes the application.

17. The system of claim 16 wherein the access type object includes a type wherein the application has unrestricted access to the service provider, a whitelist type wherein the application has unrestricted access to the service provider if the application is on an application policy list and is blocked from access to the service provider if the application is not on the application policy list, a blacklist type wherein the application has unrestricted access to the service provider if the application is not on an application policy list and is blocked from access to the service provider if the application is on the application policy list, or a vendor type wherein only an application associated with a particular vendor is allowed access to the service provider.

18. The system of claim 16 wherein the application is identified by a unique application identifier.

19. The system of claim 14 wherein the service provider sets the access permission of the application.

20. A non-transitory machine-readable storage medium storing instructions that upon execution:
communicate wirelessly with a service provider; and
determine based on an application policy whether an application stored by the storage medium has permission to access the service provider, wherein the application policy is part of a management object and sets an access permission of the application to the service provider, wherein the application policy includes an access type which indicates what kind of access permission the application policy sets and an application policy list which includes the application.
